(19) United States
(12) Patent Application Publication
(10) Pub. No.: US 2018/0162016 A1
(43) Pub. Date: Jun. 14, 2018

(54) MOLDING ELEMENT COMPRISING A SPECIAL FASTENING MEANS

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Alexandre REEB, Clermont-Ferrand (FR); Damien LEB, Clermont-Ferrand (FR); Stephane MONTZIEUX, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/104,190

(22) PCT Filed: Dec. 8, 2014
(86) PCT No.: PCT/FR2014/053217

§ 371 Date: Jun. 13, 2016

(30) Foreign Application Priority Data
Dec. 12, 2013 (FR) 1362452

(51) Int. Cl. B29C 33/42; B29C 33/10; B29C 33/38

(52) U.S. Cl. CPC B29C 33/42; B29D 2030/0612; B29C 33/3842; B29C 33/10

(57) ABSTRACT

The present invention relates to a molding element for molding a cut in a tread of a tire. The molding element includes an assembly means, this assembly means being able to connect this molding element to another molding element to form a set of molding elements. This set of molding elements is intended to be attached inside a mold.

### TECHNICAL FIELD

The present invention relates to a moulding element for moulding a cut in a tread of a tyre. The invention also relates to a set of moulding elements forming a network of moulding elements in a mould.

### PRIOR ART

Document FR2939712 discloses a set of moulding elements forming a network. The moulding elements, here bars or blades, are manufactured as a single piece by laser sintering. These moulding elements allow cuts to be moulded in a tread of a tyre.

Document WO2010076521 describes a method for manufacturing a lining comprising a complex network of blades and bars, each bar of the network over-moulding at least the edge of a blade. An intermediate step in this method involves the use of a wax to form an intermediate network of blades and of bars. This wax is then removed during a heating step in a final matrix.

The network formed by the moulding elements may be of great size. Under certain manufacturing conditions, this network may be subjected to deformations that are not negligible, causing it to become outside the acceptable manufacturing tolerances. In addition, in order to manufacture such a network, it is necessary to provide a suitable laser sintering machine and, more particularly, a large-sized plate on which to hold the network. This increases manufacturing costs. Further, when one moulding element of the network is non-compliant, it is the entire network that has to be scrapped.

There is therefore a need to find a solution that makes it possible to obtain a set of moulding elements, with good mechanical strength, which conforms to the manufacturing tolerances and which is simple and practical to manufacture.

### Definitions

A “tyre” means all types of elastic casing whether or not they are subjected to an internal pressure.

A “tread” of a tyre means a quantity of rubber material delimited by lateral surfaces and by two main surfaces, one of main surfaces is intended to come into contact with a roadway when the tyre is being driven on and the other main surface is oriented towards the inside of the tyre.

A “cut in a tread” means either a fine cut also referred to as a sipe or a wide cut also referred to as a groove.

A “moulding element” means an element placed in a mould able to produce cuts in the tread of a tyre. A moulding element able to produce a sipe in the tread is referred to as a blade. A moulding element able to produce a groove in the tread is referred to as a bar.

### SUMMARY OF THE INVENTION

The invention relates to a moulding element for moulding a cut in a tread of a tyre. The moulding element comprises an assembly means, this assembly means being able to connect this moulding element to another moulding element to form a set of moulding elements. This set of moulding elements is intended to be attached inside a mould.

Imbricating the moulding elements makes it possible to guarantee their mechanical strength during the curing of the tyre. In addition, the set of moulding elements comprising various moulding elements thus imbricated with one another is more robust. Furthermore, the various moulding elements can still be produced by laser sintering, making it possible to obtain highly complex shapes of moulding elements. It will be noted that the set of moulding elements comprising the elements assembled with one another can be fixed directly inside a mould, for example using bonding. As an alternative, the moulding elements of the set of moulding elements can be “embedded” together in aluminium, before the set of moulding elements is fitted inside the mould.

In one preferred embodiment, the moulding element comprises a lateral wall. This moulding element comprising a receiving slot in this lateral wall for receiving the other moulding element.

This method of connection is simple and practical to carry out.

In an alternative form of embodiment, the receiving slot is arranged in a part that protrudes from the lateral wall of the moulding element.

The protruding part makes it possible to improve the connection between the two moulding elements.

In another alternative form of embodiment, the receiving slot is inclined with respect to the lateral wall of the moulding element.

Angling the slot makes it possible to introduce an angle of inclination between two imbricated moulding elements.

In another alternative form of embodiment, the moulding element comprises a transverse wall roughly perpendicular to the lateral wall of this moulding element. The moulding element comprises a stud and/or a hollow on this transverse wall.

The stud and/or the hollow make(s) it possible to structure a set of moulding elements that can be adapted to the size of the mould. Furthermore, this makes it possible to obtain a set of moulding elements that is more complex.

In another alternative form of embodiment, the moulding element is a bar.

In another alternative form of embodiment, the moulding element is a blade.

In another alternative form of embodiment, the blade has an additional thickness and the assembly means are arranged in this additional thickness.

This makes it possible to make the assembly between the moulding elements more robust.

Another subject of the invention relates to a set of moulding elements intended to be attached inside a mould, this set of elements comprising an assembly of a plurality of moulding elements. Each moulding element is able to mould a cut in a tread of a tyre. Each moulding element comprises an assembly means, this assembly means being able to connect this moulding element to another moulding element to form part of the set of moulding elements.

In one preferred embodiment, all or some of the moulding elements of the set are blades of the “teardrop” type each comprising an additional thickness at one of their ends. This additional thickness comprising an assembly means. The set of elements comprises an assembly of at least two “teardrop” type blades.

In this way a network of moulding elements is obtained that is complex and robust.

### BRIEF DESCRIPTION OF THE DRAWINGS

Further features and advantages of the invention will become apparent from the following description given by way of non-limiting example with reference to the attached drawings in which:

FIG. 1 is a perspective view of a moulding element according to the invention,

FIG. 2 is a side view of the moulding element of FIG. 1, according to a second embodiment of the invention,

FIG. 3 is a perspective view of a set of moulding elements according to the invention,

FIG. 4 is a perspective view of a set of moulding elements according to a second embodiment of the invention.

In the description that follows, elements that are substantially identical or similar will be denoted by identical references.

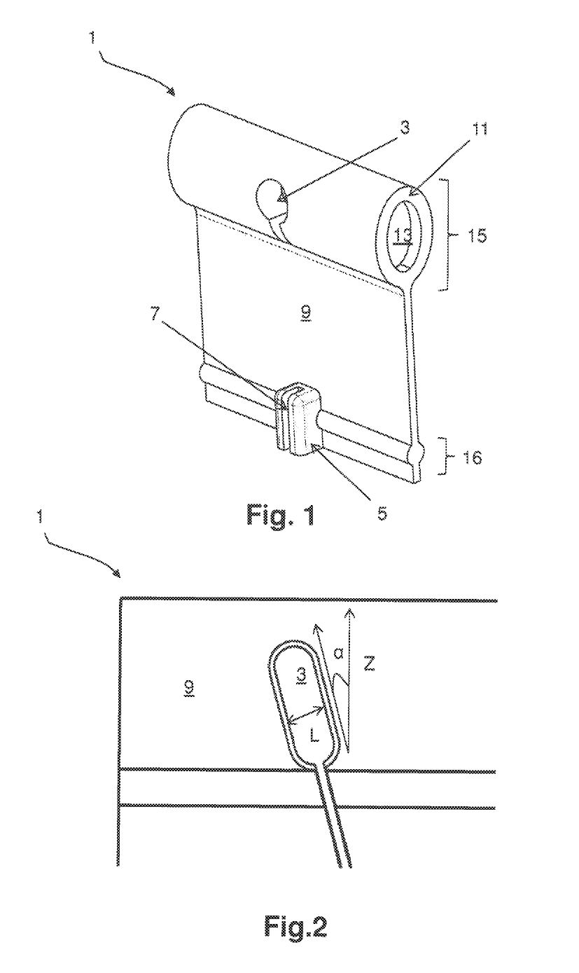

FIG. 1 shows a moulding element 1 for moulding a cut in a tread of a tyre. This moulding element 1 here has the shape of a “teardrop” type blade comprising an additional thickness at one of its ends. This moulding element 1 also comprises a second additional thickness 16, not as wide as the first additional thickness, at its base. The first additional thickness and the second additional thickness 16 here accommodate receiving slots 3, 7 for receiving another moulding element. More specifically, the receiving slot 7 associated with the second additional thickness 16 extends into a part 5 that protrudes from a lateral wall 9 of the moulding element 1. The two receiving slots 3 and 7 are aligned.

The moulding element 1 also comprises a hollow 13 on one lateral wall 11. This hollow 13 is intended to receive a stud of another moulding element in order to assemble the two moulding elements.

FIG. 2 shows an alternative form of embodiment in which the slot 3 is inclined by an angle α with respect to a vertical direction Z. This angle α is between 5° and 45°. Provision may also be made for the slot 3 to be inclined with respect to a direction normal to the lateral wall 9 of the moulding element 1. This inclination may, for example, be between 5° and 75°. In that case, the receiving slot 7 of the protruding part 5 will also be inclined by the same inclination and will be aligned with the slot 3, but the protruding part 5 will be offset from the slot 3.

It will be noted that the width L of the slot 3 may be slightly greater than the thickness of the moulding element that will be housed in this slot 3, so as to allow an assembly clearance for assembling the two moulding elements.

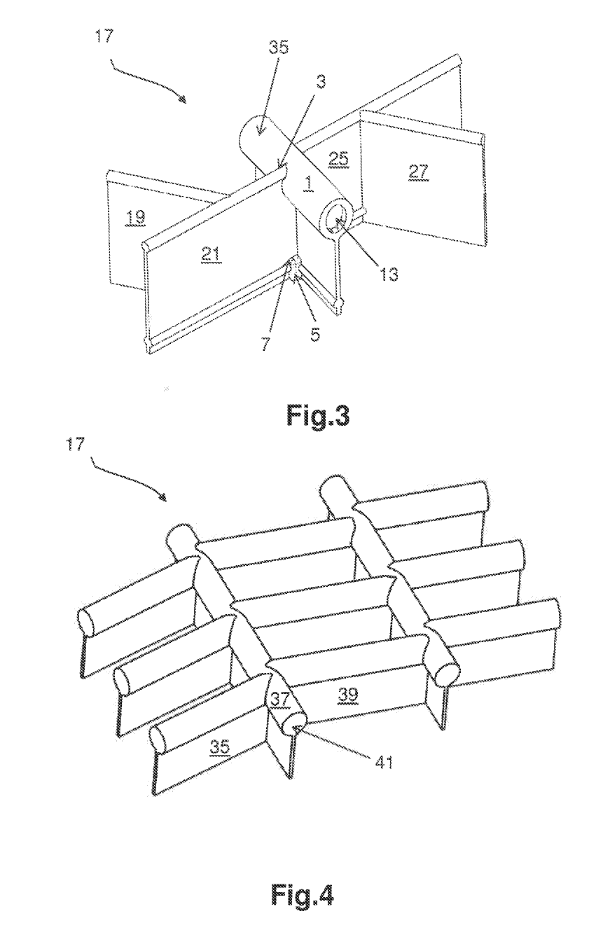

FIG. 3 depicts the moulding element 1 of FIG. 1 assembled into a set of moulding elements 17. More specifically, the set of moulding elements 17 here comprises several moulding elements 1, 19, 21, 25, 27, each moulding element being able to mould a cut in the tread of a tyre.

FIG. 4 depicts a more complex set of moulding elements comprising a plurality of “teardrop” type blades 35, 37, 39, each one comprising an additional thickness 41 at one of their ends. This additional thickness 41 is designed to accommodate means of assembling blades of “teardrop” type.

The invention is not limited to the examples described and depicted and various modifications can be made thereto without departing from the scope thereof.

Thus, in one alternative form of embodiment, the moulding element 1 of FIG. 1 is a bar.

The moulding elements are manufactured by laser sintering. As an alternative, these moulding elements are manufactured by any other manufacturing method, such as casting, machining, etc.

FIG. 1 shows slots located on widened parts of the moulding element. As an alternative, a slot may extend over a tall height of this moulding element. This is notably beneficial when the moulding element does not have widened parts but is thick enough to support the assembly means within its height.

1. A plurality of molding elements inside a mold, comprising:
an assembly of the plurality of molding elements, each of the plurality of the molding elements being able to mold a cut in a tread of a tire, wherein each of the plurality of molding elements include an assembly means the assembly means being able to connect the plurality of the molding elements to another molding element to form part of the set of the plurality of the molding elements, and
the assembly means is arranged at a lateral wall of the molding element, the assembly means including a receiving slot being configured to receive the other molding element, and in that the molding element is a blade.

2. The plurality of molding elements according to claim 1, wherein the receiving slot is arranged in a part that protrudes from the lateral wall of one of the plurality of molding elements.

3. The plurality of molding elements according to claim 1, wherein the receiving slot is inclined with respect to the lateral wall of one of the plurality of the molding elements.

4. The plurality of molding elements according to claim 1, wherein one of the plurality of molding elements includes a transverse wall substantially perpendicular to a lateral wall of the one molding element, the one molding element includes a stud and on the transverse wall.

5. The plurality of molding elements according to claim 1, wherein the blade has an additional thickness and in that the assembly means is arranged in this additional thickness.

6. The plurality of molding elements according to claim 1, wherein all or some of the plurality of molding elements of the set are blades of a “teardrop” type each including an additional thickness at one of their ends, this additional thickness including an assembly means, and in that the set of elements includes an assembly of at least two “teardrop” type blades.

7. The plurality of molding elements according to claim 1, wherein one of the plurality of molding elements includes a transverse wall substantially perpendicular to a lateral wall of the one molding element, the one molding element includes a hollow on its transverse wall.
